(19) United States
(12) Patent Application Publication
(10) Pub. No.: US 2024/0363843 A1
(43) Pub. Date: Oct. 31, 2024

(54) NEGATIVE ELECTRODE PLATE AND BATTERY

(71) Applicant: ZHUHAI COSMX BATTERY CO., LTD., Zhuhai (CN)

(72) Inventors: Ruofan CHEN, Zhuhai (CN); Chunyang LIU, Zhuhai (CN); Suli LI, Zhuhai (CN)

(73) Assignee: ZHUHAI COSMX BATTERY CO., LTD., Zhuhai (CN)

(21) Appl. No.: 18/767,827

(22) Filed: Jul. 9, 2024

Related U.S. Application Data
(63) Continuation of application No. PCT/CN2023/076462, filed on Feb. 16, 2023.

(30) Foreign Application Priority Data
Mar. 2, 2022 (CN) 202210199355.2

(51) Int. Cl. H01M 4/36; H01M 4/02; H01M 4/133; H01M 4/587; H01M 4/62

(52) U.S. Cl. CPC H01M 4/366; H01M 4/133; H01M 4/587; H01M 4/622; H01M 4/625; H01M 2004/021; H01M 2004/027

(57) ABSTRACT

Disclosed are a negative electrode plate and a battery including the negative electrode plate. The negative electrode plate includes a negative electrode current collector, and a first coating region, a second coating region, and a third coating region sequentially disposed along a width direction of the negative electrode current collector. In the present disclosure, a negative electrode plate is designed with a special structure and composition, which solves a problem that lithium deposition easily occurs at the head and bottom during application of a multi-tab winding structure, so that the multi-tab winding structure may be better applied in batteries.

### CROSS-REFERENCE TO RELATED APPLICATIONS

The present disclosure is a continuation application of International Application No. PCT/CN2023/076462, filed on Feb. 16, 2023, which claims priority to Chinese Patent Application No. CN202210199355.2, filed on Mar. 2, 2022. The disclosures of the aforementioned applications are hereby incorporated by reference in their entireties.

### TECHNICAL FIELD

The present disclosure belongs to the field of secondary battery technologies, and in particular, to a negative electrode plate and a battery including the negative electrode plate.

### BACKGROUND

As application scenarios of lithium-ion batteries expand, both electric vehicles and consumer batteries have shown an urgent need to shorten a charging time. In terms of performance of lithium-ion battery cells, improving a charging speed has become a technical problem that needs to be urgently solved.

A multi-tab winding structure is a lithium-ion battery structure that is currently being studied the most, and features a fast charging speed. However, there is often a problem that lithium deposition easily occurs at the head and bottom of a battery cell during application of the multi-tab winding structure, which limits the application and development of this structure.

Therefore, it is urgent and very important to develop a battery that can solve the problem of lithium deposition at the head and bottom of the battery cell in the multi-tab winding structure.

### SUMMARY

To overcome the disadvantages in the foregoing technologies, the present disclosure provides a negative electrode plate and a battery including the negative electrode plate. In the present disclosure, a negative electrode plate is designed with a special structure and composition, which solves a problem that lithium deposition easily occurs at the head and bottom during application of a battery with a multi-tab winding structure, so that the multi-tab winding structure may be better applied in batteries.

The present disclosure is implemented by using the following technical solutions.

A negative electrode plate is provided, including a negative electrode current collector, and a first coating region, a second coating region, and a third coating region sequentially disposed along a width direction of the negative electrode current collector.

A first negative electrode active material layer is disposed in the first coating region, where the first negative electrode active material layer includes a first negative electrode active material, and the first negative electrode active material includes a first graphite material and a first amorphous carbon material.

A second negative electrode active material layer is disposed in the second coating region, where the second negative electrode active material layer includes a second negative electrode active material, and the second negative electrode active material includes a second graphite material.

A third negative electrode active material layer is disposed in the third coating region, where the third negative electrode active material layer includes a third negative electrode active material, and the third negative electrode active material includes a third graphite material and a second amorphous carbon material.

The negative electrode plate is designed to be the foregoing negative electrode plate with a special structure and composition including the three coating regions, so that the problem that lithium deposition easily occurs at the head and bottom during application of the battery with the multi-tab winding structure can be solved.

The present disclosure further provides a battery, and the battery includes the foregoing negative electrode plate.

Beneficial effects of the present disclosure are as follows.

The present disclosure provides a negative electrode plate and a battery including the negative electrode plate. In the present disclosure, a negative electrode plate is designed with a special structure and composition, which solves a problem that lithium deposition easily occurs at the head and bottom during application of a multi-tab winding structure, so that the multi-tab winding structure may be better applied in batteries.

### BRIEF DESCRIPTION OF THE DRAWINGS

FIG. 1 is a schematic structural diagram of a negative electrode plate according to a preferred solution of the present disclosure.

FIG. 2 is a schematic structural diagram of assembly of a positive electrode plate and a negative electrode plate in a battery according to a preferred solution of the present disclosure.

### DETAILED DESCRIPTION OF THE EMBODIMENTS

The present disclosure is further described in detail below with reference to specific embodiments. It should be understood that the following embodiments are merely for the purposes of illustrating and explaining the present disclosure, and should not be construed as limiting the scope of protection of the present disclosure. Any technology implemented based on the foregoing contents of the present disclosure falls within the intended scope of protection of the present disclosure.

In an example, a negative electrode plate is applicable to a multi-tab battery. The multi-tab battery means a battery with three or more tabs.

In an example, stripe coating, for example, is applied to a surface of a negative electrode current collector in the negative electrode plate in the present disclosure, to be specific, a first coating region, a second coating region, and a third coating region are sequentially disposed along a width direction of the negative electrode current collector.

In an example, a sum of a width W1 of the first coating region, a width W2 of the second coating region, and a width W3 of the third coating region is a width W_{collector} of the negative electrode current collector, in other words, W1+W2+W3=W_{collector}.

In an example, the width W1 of the first coating region meets:

$$Overhang 1 < W 1 \leq 5 \times Overhang 1.$$

Overhang1 refers to a width by which the negative electrode plate close to a side of the first coating region extends beyond a side of a positive electrode plate 22 when the positive electrode plate and the negative electrode plate are covered. As shown in FIG. 2, 21 represents Overhang1, and a represents the width direction.

In an example, the width W3 of the third coating region meets:

$$Overhang 3 < W 3 \leq 5 \times Overhang 3.$$

Overhang3 refers to a width by which the negative electrode plate close to a side of the third coating region extends beyond a side of a positive electrode plate 22 when the positive electrode plate and the negative electrode plate are covered. As shown in FIG. 2, 23 represents Overhang3.

In the present disclosure, the width W1 of the first coating region and the width W3 of the third coating region are adjusted, so that when the positive electrode plate and the negative electrode plate are covered, the width Overhang1 by which the negative electrode plate close to the side of the first coating region extends beyond the side of the positive electrode plate and the width Overhang3 by which the negative electrode plate close to the side of the third coating region extends beyond the side of the positive electrode plate are within a proper range, thereby solving a problem of lithium deposition at the head and bottom of the negative electrode plate.

If the range is too small (W1≤Overhang1 and/or W3≤Overhang3), a region in which lithium deposition often occurs cannot be covered, and consequently, the problem of lithium deposition cannot be solved. If the range is too large (W1>5×Overhang1 and/or W3>5×Overhang3), energy density of the battery is affected.

In an example, a thickness of a first negative electrode active material layer, a thickness of a second negative electrode active material layer, and a thickness of a third negative electrode active material layer are the same, and range from 23 μm to 53 μm (for example, 23 μm, 25 μm, 28 μm, 30 μm, 33 μm, 35 μm, 38 μm, 40 μm, 43 μm, 45 μm, 48 μm, 50 μm, or 53 μm).

In an example, a first amorphous carbon material and a second amorphous carbon material may be purchased commercially or may be prepared by using a method known in the art.

In an example, the first amorphous carbon material and the second amorphous carbon material are the same or different and are independently selected from at least one of hard carbon, soft carbon, porous carbon, or the like.

In an example, the first amorphous carbon material and the second amorphous carbon material are the same or different and are independently selected from high-capacity amorphous carbon. The selection of the high-capacity amorphous carbon may greatly improve energy density of a battery cell while reducing a risk of lithium deposition.

Preferably, a capacity of the high-capacity amorphous carbon is greater than or equal to 500 mAh/g.

In an example, a particle size Dv50 of a first graphite material ranges from 9 μm to 14 μm (for example, 9 μm, 10 μm, 11 μm, 12 μm, 13 μm, or 14 μm).

In an example, a particle size Dv50 of a second graphite material ranges from 9 μm to 14 μm (for example, 9 μm, 10 μm, 11 μm, 12 μm, 13 μm, or 14 μm).

In an example, a particle size Dv50 of a third graphite material ranges from 9 μm to 14 μm (for example, 9 μm, 10 μm, 11 μm, 12 μm, 13 μm, or 14 μm).

In an example, a particle size Dv50 of the first amorphous carbon material ranges from 3μ m to 9μ m (for example, 3 μm, 4 μm, 5μ, 6 μm, 7μ, 8 μm, or 9μ m).

In an example, a particle size Dv50 of the second amorphous carbon material ranges from 3 μm to 9 μm (for example, 3 μm, 4 μm, 5 μm, 6 μm, 7 μm, 8 μm, or 9 μm).

In an example, the first negative electrode active material layer further includes a first conductive agent, a first thickener, and a first binder.

In an example, the second negative electrode active material layer further includes a second conductive agent, a second thickener, and a second binder.

In an example, the third negative electrode active material layer further includes a third conductive agent, a third thickener, and a third binder.

In an example, the first conductive agent forming the first negative electrode active material layer, the second conductive agent forming the second negative electrode active material layer, and the third conductive agent forming the third negative electrode active material layer are the same or different.

The first conductive agent, the second conductive agent, and the third conductive agent are the same or different and are independently selected from at least one of conductive carbon black, acetylene black, Ketjen black, conductive graphite, conductive carbon fiber, carbon nanotube, or metal powder.

In an example, the first thickener forming the first negative electrode active material layer, the second thickener forming the second negative electrode active material layer, and the third thickener forming the third negative electrode active material layer are the same or different.

The first thickener, the second thickener, and the third thickener are the same or different and are independently selected from at least one of sodium carboxymethyl cellulose or lithium carboxymethyl cellulose.

In an example, the first binder forming the first negative electrode active material layer, the second binder forming the second negative electrode active material layer, and the third binder forming the third negative electrode active material layer are the same or different.

The first binder, the second binder, and the third binder are the same or different and are independently selected from at least one of styrene-butadiene rubber (SBR), polyacrylonitrile, polystyrene-acrylate, or polyacrylic acid ester.

In an example, mass percentages of components in the first negative electrode active material layer are: 93 wt % to 98 wt % (for example, 93 wt %, 94 wt %, 95 wt %, 96 wt %, 97 wt %, or 98 wt %) first negative electrode active material, 0.4 wt % to 2 wt % (for example, 0.4 wt %, 0.5 wt %, 1 wt %, 1.5 wt %, or 2 wt %) first conductive agent, 0.5 wt % to 3.5 wt % (for example, 0.5 wt %, 1 wt %, 1.5 wt %, 2 wt %, 2.5 wt %, 3 wt %, or 3.5 wt %) first binder, and 0.3 wt % to 1.7 wt % (for example, 0.3 wt %, 0.5 wt %, 1 wt %, 1.5 wt %, or 1.7 wt %) first thickener.

In an example, mass percentages of components in the second negative electrode active material layer are: 95 wt % to 99 wt % (for example, 95 wt %, 96 wt %, 97 wt %, 98 wt %, or 99 wt %) second negative electrode active material, 0.4 wt % to 2 wt % (for example, 0.4 wt %, 0.5 wt %, 1 wt %, 1.5 wt %, or 2 wt %) second conductive agent, 0.5 wt % to 2.5 wt % (for example, 0.5 wt %, 1 wt %, 1.5 wt %, 2 wt %, or 2.5 wt %) second binder, and 0.3 wt % to 1.3 wt % (for example, 0.3 wt %, 0.5 wt %, 1 wt %, or 1.3 wt %) second thickener.

In an example, mass percentages of components in the third negative electrode active material layer are: 93 wt % to 98 wt % (for example, 93 wt %, 94 wt %, 95 wt %, 96 wt %, 97 wt %, or 98 wt %) third negative electrode active material, 0.4 wt % to 2 wt % (for example, 0.4 wt %, 0.5 wt %, 1 wt %, 1.5 wt %, or 2 wt %) third conductive agent, 0.5 wt % to 3.5 wt % (for example, 0.5 wt %, 1 wt %, 1.5 wt %, 2 wt %, 2.5 wt %, 3 wt %, or 3.5 wt %) third binder, and 0.3 wt % to 1.7 wt % (for example, 0.3 wt %, 0.5 wt %, 1 wt %, 1.5 wt %, or 1.7 wt %) third thickener.

In an example, a mass ratio of the first graphite material to the first amorphous carbon material is (60 wt % to 94 wt %):(40 wt % to 6 wt %). It may be understood that a mass percentage of the first graphite material may range from 60 wt % to 94 wt %, and a mass percentage of the first amorphous carbon material may range from 40 wt % to 6 wt %, but the following needs to be met: A sum of the mass percentage of the first graphite material and the mass percentage of the first amorphous carbon material is 100 wt %.

In an example, a mass ratio of the third graphite material to the second amorphous carbon material is (60 wt % to 94 wt %):(40 wt % to 6 wt %). It may be understood that a mass percentage of the third graphite material may range from 60 wt % to 94 wt %, and a mass percentage of the second amorphous carbon material may range from 40 wt % to 6 wt %, but the following needs to be met: A sum of the mass percentage of the third graphite material and the mass percentage of the second amorphous carbon material is 100 wt %.

In the present disclosure, it has been found through research that the thicknesses of the first negative electrode active material layer, the second active material layer, and the third active material layer on the surface of the negative electrode current collector may be controlled to be consistent by combining different proportions of amorphous carbon negative electrode materials (a mass ratio of a graphite material to an amorphous carbon material is (60 wt % to 94 wt %):(40 wt % to 6 wt %)). If a proportion of the amorphous carbon material is too small, lithium deposition cannot be improved. If a mixing ratio is too large, a cycling thickness expansion rate of the first negative electrode active material layer and a cycling thickness expansion rate of the third negative electrode active material layer are significantly reduced compared with a cycling thickness expansion rate of the second negative electrode active material layer (the amorphous carbon material is considered to be a negative electrode material that does not expand during cycling). As the cycling proceeds, the thickness of the first negative electrode active material layer and the thickness of the third negative electrode active material layer are significantly different from the thickness of the second negative electrode active material layer, to be specific, the thickness of the first negative electrode active material layer and the thickness of the third negative electrode active material layer are smaller, while the thickness of the second negative electrode active material layer is larger. This results in peeling off of the first negative electrode active material layer, the second negative electrode active material layer, and the third negative electrode active material layer, and obvious damage occurs.

In an example, the negative electrode plate further includes tabs.

In an example, the tabs are disposed in a foil uncoating region disposed along the width direction of the negative electrode current collector and close to the first coating region.

In an example, the tabs are disposed close to the first coating region, and the tabs are formed by extension of the negative electrode current collector.

In an example, there are at least three tabs.

Experimental methods used in the following examples are conventional methods, unless otherwise specified. Reagents, materials, and the like used in the following examples are all commercially available, unless otherwise specified.

In the description of the present disclosure, it should be noted that the terms “first”, “second”, “third”, or the like, are only used for descriptive purposes, and do not indicate or imply relative importance.

### Performance Test

### Test for Volumetric Energy Density/Wh/L:

Volumetric energy density=initial capacity/battery cell volume(if the battery cell is a cuboid, the battery cell volume is length×width×height)

A capacity discharged when a battery cell is discharged to 3 V at a current of 0.2 C after the battery cell is charged to a cell upper limit voltage (4.48 V) at a constant current of 0.5 C and a constant voltage at room temperature is the initial capacity.

Test for Expansion Rate after 300 Cycles:

At 25° C., each of the batteries of examples and a comparative example is charged to 4.45 V at a constant current rate of 5 C, then charged at a constant voltage of 4.45 V with a cut-off current of 0.025 C, and then discharged at a constant current rate of 0.7 C with a cut-off voltage of 3 V. This is a charge-discharge cycle process. The charge-discharge cycle process is repeated until a quantity of cycles of the battery reaches 300, and at the same time, a cycling expansion rate of the battery is tested after the 300 cycles are performed for the battery. A calculation method is as follows: before the cycling, a fully-charged battery thickness is tested with a thickness tester as an initial thickness, and a thickness of the battery after the battery is fully charged after the 300 cycles are completed is tested and recorded. Cycling expansion rate=(cycling fully-charged battery thickness/initial fully-charged battery thickness)×100%.

Test for Capacity Retention Rate at 5 C after 20 Cycles:

At 25° C., each of the batteries of the examples and the comparative example is charged to 4.45 V at a constant current rate of 5 C, then charged at a constant voltage of 4.45 V with a cut-off current of 0.025 C, and then discharged at a constant current rate of 0.7 C with a cut-off voltage of 3 V, and an initial capacity Q0 is recorded. This is a charge-discharge cycle process. The charge-discharge cycle process is repeated until a quantity of cycles of the battery reaches 20. A discharge capacity of the 20th cycle is used as a capacity Q3 of the battery to calculate a capacity retention rate. Capacity retention rate (%)=Q3/Q0×100%.

### Example 1

Graphite and hard carbon were mixed as a first negative electrode active material, and the first negative electrode active material (using a total weight of a first negative electrode active material layer as a reference, a weight content of the first negative electrode active material was 96 wt %, where using a total weight of the first negative electrode active material as a reference, a graphite mass proportion was 97 wt % and a hard carbon mass proportion was 3 wt %), conductive carbon black as a first conductive agent (using the total weight of the first negative electrode active material layer as a reference, a weight content of the first conductive agent was 1.5 wt %), an SBR type binder as a first binder (using the total weight of the first negative electrode active material layer as a reference, a weight content of the first binder was 1.3 wt %), and sodium carboxymethyl cellulose CMC as a first thickener (using the total weight of the first negative electrode active material layer as a reference, a weight content of the first thickener was 1.2 wt %), and deionized water were added to a homogenizer by step and mixed and stirred to obtain a uniformly dispersed negative electrode slurry 1 with a solid content ranging from 43 wt % to 48 wt %.

Graphite was used as a second negative electrode active material, and the second negative electrode active material (using a total weight of a second negative electrode active material layer as a reference, a weight content of the second negative active material was 96 wt %), conductive carbon black as a second conductive agent (using the total weight of the second negative electrode active material layer as a reference, a weight content of the second conductive agent was 1.5 wt %), an SBR type binder as a second binder (using the total weight of the second negative electrode active material layer as a reference, a weight content of the second binder was 1.3 wt %), and sodium carboxymethyl cellulose CMC as a second thickener (using the total weight of the second negative electrode active material layer as a reference, a weight content of the second thickener was 1.2 wt %), and deionized water were added to the homogenizer by step and mixed and stirred to obtain a uniformly dispersed negative electrode slurry 2 with a solid content ranging from 43 wt % to 48 wt %.

Graphite and hard carbon were mixed as a third negative electrode active material, and the third negative electrode active material (using a total weight of a third negative electrode active material layer as a reference, a weight content of the third negative electrode active material was 96 wt %, where using a total weight of the third negative electrode active material as a reference, a graphite mass proportion was 97% and a hard carbon mass proportion was 3%), conductive carbon black as a third conductive agent (using the total weight of the third negative electrode active material layer as a reference, a weight content of the third conductive agent was 1.5 wt %), an SBR type binder as a third binder (using the total weight of the third negative electrode active material layer as a reference, a weight content of the third binder was 1.3 wt %), and sodium carboxymethyl cellulose CMC as a third thickener (using the total weight of the third negative electrode active material layer as a reference, a weight content of the third thickener was 1.2 wt %), and deionized water were added to the homogenizer by step and mixed and stirred to obtain a uniformly dispersed negative electrode slurry 3 with a solid content ranging from 43 wt % to 48 wt %.

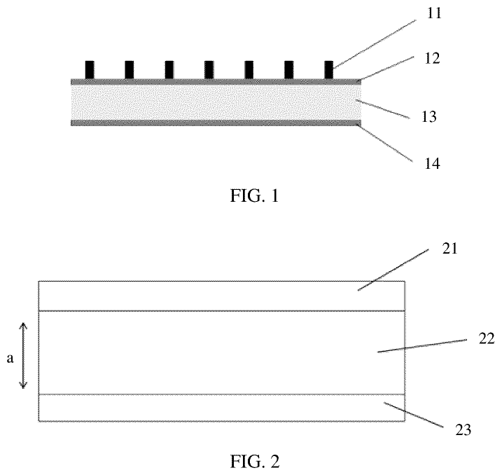

The three slurries were applied on a surface of copper foil with a thickness of 6 μm by using an extrusion coating machine. It should be noted that a coating die head is designed based on regions. According to a design in FIG. 1, along a width direction of a negative electrode current collector, there are three regions that are distributed corresponding to the negative electrode slurry 1, the negative electrode slurry 2, and the negative electrode slurry 3. A coating speed was 5 m/min. After coating, backing was performed. The negative electrode slurry 1 formed the first negative electrode active material layer, the negative electrode slurry 2 formed the second negative electrode active material layer, and the negative electrode slurry 3 formed the third negative electrode active material layer. Then, rolling and cutting were performed to obtain a negative electrode plate. A rolling pressure used this time was adjusted to 50 MPa to obtain the negative electrode plate.

The negative electrode plate includes a negative electrode current collector, and a first coating region 12, a second coating region 13, and a third coating region 14 sequentially disposed along a width direction of the negative electrode current collector.

A first negative electrode active material layer is disposed in the first coating region 12, where the first negative electrode active material layer includes a first negative electrode active material, and the first negative electrode active material includes a first graphite material and a first amorphous carbon material.

A second negative electrode active material layer is disposed in the second coating region 13, where the second negative electrode active material layer includes a second negative electrode active material, and the second negative electrode active material includes a second graphite material.

A third negative electrode active material layer is disposed in the third coating region 14, where the third negative electrode active material layer includes a third negative electrode active material, and the third negative electrode active material includes a third graphite material and a second amorphous carbon material.

The negative electrode plate further includes tabs 11. The tabs 11 are disposed close to the first coating region 12, and the tabs are formed by extension of the negative electrode current collector.

Various parameters of the negative electrode plate are shown in Table 1.

TABLE 1
Structural parameters of the negative electrode plate in Example 1

| | | | | | | Thickness | |
|---|---|---|---|---|---|---|---|
| | | | Surface | Press | | of coating 1 = | Hard |
| | Overhang1 = | | density of | density of | | thickness | carbon |
| | Overhang3/ | W1 = | coating | coating | W2/ | of coating | capacity/ |
| | mm | W3/mm | 2/g/cm² | 2/g/cm³ | mm | 3/μm | mAh/g |
| Example 1 | 2 | 6 | 7.27 | 1.54 | 47.2 | 47.2 | 530 |

A positive electrode active material LiCoO₂, a binder PVDF, and a conductive agent Super P were dissolved in N-methylpyrrolidone (NMP) at a mass ratio of 97%:1.5%:1.5%, a resulting mixture was stirred evenly to form a slurry, and the slurry was evenly applied on surfaces of both sides of aluminum foil of a positive electrode current collector, followed by baking at 125° C. for 6 hours, cold pressing, and cutting to prepare a positive electrode plate for a lithium-ion battery.

The prepared positive electrode plate, the prepared negative electrode plate, and a polyethylene separator were wound by using a winding machine to obtain a jelly roll of a winding structure with a positive electrode wrapped outside, and the jelly roll was packaged with an aluminum-plastic film. After baking was performed under vacuum for 48 hours to remove moisture, an electrolyte solution was injected, and then conventional forming and sorting of a battery were performed to obtain a pouch lithium-ion battery. The electrolyte solution was an electrolyte solution prepared by a conventional electrolyte solution formula: LiPF₆+Solvent (EC+DEC+DMC).

### Example 2 to Example 7 and Comparative Example 1

Other operations are the same as those in Example 1, and a difference only lies in that mixing ratios of hard carbon in the first negative electrode active material layer and the third negative electrode active material layer are different. This is specifically shown in Table 2, where a hard carbon mass proportion represents each of the hard carbon mass proportion of the first negative electrode active material layer and the hard carbon mass proportion of the third negative electrode active material, and the hard carbon mass proportions of the two layers are the same, and therefore are expressed with a same numerical value; and a graphite mass proportion represents each of the graphite mass proportion of the first negative electrode active material layer and the graphite mass proportion of the third negative electrode active material, and the graphite mass proportions of the two layers are the same, and therefore are expressed with a same numerical value.

TABLE 2
Performance test results of parameters of the
negative electrode plates and batteries in Example
1 to Example 7 and Comparative Example 1

| | Hard | Graphite | Energy | Expansion rate |
|---|---|---|---|---|
| | carbon mass | mass | density/ | after 300 |
| | proportion | proportion | Wh/L | cycles |
| Example 1 | 3% | 97% | 605 | 6.83% |
| Example 2 | 6% | 94% | 595 | 6.83% |
| Example 3 | 10% | 90% | 582 | 6.83% |
| Example 4 | 20% | 80% | 548 | 6.83% |
| Example 5 | 30% | 70% | 526 | 6.30% |
| Example 6 | 40% | 60% | 481.7 | 5.71% |
| Example 7 | 50% | 50% | 448.3 | 5.60% |
| Comparative | 0% | 100% | 615 | 6.83% |
| Example 1 | | | | |

### Example 8

Graphite and hard carbon were mixed as a first negative electrode active material, and the first negative electrode active material (using a total weight of a first negative electrode active material layer as a reference, a weight content of the first negative electrode active material was 96 wt %, where using a total weight of the first negative electrode active material as a reference, a graphite mass proportion was 92% and a hard carbon mass proportion was 8%), conductive carbon black as a first conductive agent (using the total weight of the first negative electrode active material layer as a reference, a weight content of the first conductive agent was 1.5 wt %), an SBR type binder as a first binder (using the total weight of the first negative electrode active material layer as a reference, a weight content of the first binder was 1.3 wt %), and sodium carboxymethyl cellulose CMC as a first thickener (using the total weight of the first negative electrode active material layer as a reference, a weight content of the first thickener was 1.2 wt %), and deionized water were added to a homogenizer by step and mixed and stirred to obtain a uniformly dispersed negative electrode slurry 1 with a solid content ranging from 43 wt % to 48 wt %.

Graphite was used as a second negative electrode active material, and the second negative electrode active material (using a total weight of a second negative electrode active material layer as a reference, a weight content of the second active material was 96 wt %), conductive carbon black as a second conductive agent (using the total weight of the second negative electrode active material layer as a reference, a weight content of the second conductive agent was 1.5 wt %), an SBR type binder as a second binder (using the total weight of the second negative electrode active material layer as a reference, a weight content of the second binder was 1.3 wt %), and sodium carboxymethyl cellulose CMC as a second thickener (using the total weight of the second negative electrode active material layer as a reference, a weight content of the second thickener was 1.2 wt %), and deionized water were added to the homogenizer by step and mixed and stirred to obtain a uniformly dispersed negative electrode slurry 2 with a solid content ranging from 43 wt % to 48 wt %.

Graphite and hard carbon were mixed as a third negative electrode active material, and the third negative electrode active material (using a total weight of a third negative electrode active material layer as a reference, a weight content of the third negative electrode active material was 96 wt %, where using a total weight of the third negative electrode active material as a reference, a graphite mass proportion was 92% and a hard carbon mass proportion was 8%), conductive carbon black as a third conductive agent (using the total weight of the third negative electrode active material layer as a reference, a weight content of the third conductive agent was 1.5 wt %), an SBR type binder as a third binder (using the total weight of the third negative electrode active material layer as a reference, a weight content of the third binder was 1.3 wt %), and sodium carboxymethyl cellulose CMC as a third thickener (using the total weight of the third negative electrode active material layer as a reference, a weight content of the third thickener was 1.2 wt %), and deionized water were added to the homogenizer by step and mixed and stirred to obtain a uniformly dispersed negative electrode slurry 3 with a solid content ranging from 43 wt % to 48 wt %.

The three slurries were applied on a surface of copper foil with a thickness of 6 μm by using an extrusion coating machine. It should be noted that a coating die head is designed based on regions. According to a design in FIG. 1, along a width direction of a negative electrode current collector, there are three regions that are distributed corresponding to the negative electrode slurry 1, the negative electrode slurry 2, and the negative electrode slurry 3. A coating speed was 5 m/min. After coating, backing was performed. The negative electrode slurry 1 formed the first negative electrode active material layer, the negative electrode slurry 2 formed the second negative electrode active material layer, and the negative electrode slurry 3 formed the third negative electrode active material layer. Then, rolling and cutting were performed to obtain a negative electrode plate. A rolling pressure used this time was adjusted to 50 MPa to obtain the negative electrode plate.

The negative electrode plate includes a negative electrode current collector, and a first coating region 12, a second coating region 13, and a third coating region 14 sequentially disposed along a width direction of the negative electrode current collector.

A first negative electrode active material layer is disposed in the first coating region 12, where the first negative electrode active material layer includes a first negative electrode active material, and the first negative electrode active material includes a first graphite material and a first amorphous carbon material.

A second negative electrode active material layer is disposed in the second coating region 13, where the second negative electrode active material layer includes a second negative electrode active material, and the second negative electrode active material includes a second graphite material.

A third negative electrode active material layer is disposed in the third coating region 14, where the third negative electrode active material layer includes a third negative electrode active material, and the third negative electrode active material includes a third graphite material and a second amorphous carbon material.

The negative electrode plate further includes tabs 11. The tabs 11 are disposed close to the first coating region 12, and the tabs are formed by extension of the negative electrode current collector.

Various parameters of the negative electrode plate are shown in Table 3.

A positive electrode active material LiCoO₂, a binder PVDF, and a conductive agent Super P were dissolved in N-methylpyrrolidone (NMP) at a mass ratio of 97%:1.5%:1.5%, a resulting mixture was stirred evenly to form a slurry, and the slurry was evenly applied on surfaces of both sides of aluminum foil of a positive electrode current collector, followed by baking at 125° C. for 6 hours, cold pressing, and cutting to prepare a positive electrode plate for a lithium-ion battery.

The prepared positive electrode plate, the prepared negative electrode plate, and a polyethylene separator were wound by using a winding machine to obtain a jelly roll of a winding structure with a positive electrode wrapped outside, and the jelly roll was packaged with an aluminum-plastic film. After baking was performed under vacuum for 48 hours to remove moisture, an electrolyte solution was injected, and then conventional forming and sorting of a battery were performed to obtain a pouch lithium-ion battery. The electrolyte solution was an electrolyte solution prepared by a conventional electrolyte solution formula: LiPF₆+Solvent (EC+DEC+DMC).

### Example 9 to Example 14

Other operations are the same as those in Example 8, and a difference only lies in that structures of negative electrode plates are different. This is specifically shown in Table 3.

TABLE 3
Structural parameters of the negative electrode plates in Example 8 to Example 14

| | | | | | | Thickness | |
|---|---|---|---|---|---|---|---|
| | | | Surface | Press | | of coating 1 = | Hard |
| | Overhang1 = | | density of | density of | | thickness | carbon |
| | Overhang3/ | W1 = | coating | coating | W2/ | of coating | capacity/ |
| | mm | W3/mm | 2/g/cm² | 2/g/cm³ | mm | 3/μm | mAh/g |
| Example 8 | 2 | 13 | 7.27 | 1.54 | 47.2 | 47.2 | 530 |
| Example 9 | 2 | 12 | | | | 47.2 | |
| Example 10 | 2 | 1.8 | | | | 47.2 | |
| Example 11 | 2 | 2 | | | | 47.2 | |
| Example 12 | 2 | 4 | | | | 47.2 | |
| Example 13 | 2 | 6 | | | | 47.2 | |
| Example 14 | 2 | 6 | | | | 49.2 | 330 |

Performance test results of the batteries in Example 8 to Example 14 are listed in Table 4.

TABLE 4
Performance test results of the batteries
in Example 8 to Example 14

| | Energy | Capacity retention rate |
|---|---|---|
| | density/Wh/L | at 5 C after 20 cycles/% |
| Example 8 | 541.0 | 99.41% |
| Example 9 | 547.7 | 99.41% |
| Example 10 | 615.0 | 96.36% |
| Example 11 | 615.0 | 96.67% |
| Example 12 | 601.5 | 99.76% |
| Example 13 | 588.1 | 99.76% |
| Example 14 | 565.1 | 99.59% |

It is generally considered that a problem of a lithium deposition window may be solved as long as the width Overhang1 is the same as the width of the coating 1 and the width Overhang3 is the same as the width the coating 3. However, in the present disclosure, it has been found through research that a desired effect cannot be achieved under the same conditions.

This is because even under the same conditions, an edge effect of the positive electrode plate still affects a performance state of the coating 2. The edge effect of the positive electrode plate can be avoided to the greatest extent only when conditions of the present disclosure are met. To be specific, when the width Overhang1, the width Overhang3, the width W1 of the coating 1, and the width W3 of the coating 3 meet some conditions (Overhang1<W1≤5×Overhang1, and Overhang3<W3≤5×Overhang3), a relationship between energy density and the lithium deposition window may be balanced to the greatest extent.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

What is claimed is:

1. A negative electrode plate, comprising a negative electrode current collector, and a first coating region, a second coating region, and a third coating region sequentially disposed along a width direction of the negative electrode current collector;
a first negative electrode active material layer disposed in the first coating region, wherein the first negative electrode active material layer comprises a first negative electrode active material, and the first negative electrode active material comprises a first graphite material and a first amorphous carbon material;
a second negative electrode active material layer disposed in the second coating region, wherein the second negative electrode active material layer comprises a second negative electrode active material, and the second negative electrode active material comprises a second graphite material; and
a third negative electrode active material layer disposed in the third coating region, wherein the third negative electrode active material layer comprises a third negative electrode active material, and the third negative electrode active material comprises a third graphite material and a second amorphous carbon material.

2. The negative electrode plate according to claim 1, wherein a sum of a width W1 of the first coating region, a width W2 of the second coating region, and a width W3 of the third coating region is a width W_{collector} of the negative electrode current collector, in other words, W1+W2+W3=W_{collector}.

3. The negative electrode plate according to claim 2, wherein the width W1 of the first coating region meets:
Overhang1<W1≤5×Overhang1, wherein
Overhang1 refers to a width by which the negative electrode plate close to a side of the first coating region extends beyond a side of a positive electrode plate when the positive electrode plate and the negative electrode plate are covered.

4. The negative electrode plate according to claim 2, wherein the width W3 of the third coating region meets:
Overhang3<W3≤5×Overhang3, wherein
Overhang3 refers to a width by which the negative electrode plate close to a side of the third coating region extends beyond a side of a positive electrode plate when the positive electrode plate and the negative electrode plate are covered.

5. The negative electrode plate according to claim 1, wherein a thickness of the first negative electrode active material layer, a thickness of the second negative electrode active material layer, and a thickness of the third negative electrode active material layer are the same, and range from 23 μm to 53 μm.

6. The negative electrode plate according to claim 1, wherein the first amorphous carbon material and the second amorphous carbon material are the same or different and are independently selected from at least one of hard carbon, soft carbon, or porous carbon; and/or
the first amorphous carbon material and the second amorphous carbon material are the same or different and are independently selected from high-capacity amorphous carbon, and a capacity of the high-capacity amorphous carbon is greater than or equal to 500 mAh/g.

7. The negative electrode plate according to claim 1, wherein a particle size Dv50 of the first graphite material ranges from 9 μm to 14 μm; and/or
a particle size Dv50 of the second graphite material ranges from 9 μm to 14 μm; and/or
a particle size Dv50 of the third graphite material ranges from 9 μm to 14 μm.

8. The negative electrode plate according to claim 1, wherein a particle size Dv50 of the first amorphous carbon material ranges from 3 μm to 9 μm; and/or
a particle size Dv50 of the second amorphous carbon material ranges from 3 μm to 9 μm.

9. The negative electrode plate according to claim 1, wherein the first negative electrode active material layer further comprises a first conductive agent, a first thickener, and a first binder; and/or
the second negative electrode active material layer further comprises a second conductive agent, a second thickener, and a second binder; and/or
the third negative electrode active material layer further comprises a third conductive agent, a third thickener, and a third binder.

10. The negative electrode plate according to claim 9, wherein the first conductive agent, the second conductive agent, and the third conductive agent are the same or different and are independently selected from at least one of conductive carbon black, acetylene black, Ketjen black, conductive graphite, conductive carbon fiber, carbon nanotube, or metal powder; and/or
the first thickener, the second thickener, and the third thickener are the same or different and are independently selected from at least one of sodium carboxymethyl cellulose or lithium carboxymethyl cellulose; and/or
the first binder, the second binder, and the third binder are the same or different and are independently selected from at least one of styrene-butadiene rubber, polyacrylonitrile, polystyrene-acrylate, or polyacrylic acid ester.

11. The negative electrode plate according to claim 9, wherein mass percentages of components in the first negative electrode active material layer are: 93 wt % to 98 wt % first negative electrode active material, 0.4 wt % to 2 wt % first conductive agent, 0.5 wt % to 3.5 wt % first binder, and 0.3 wt % to 1.7 wt % first thickener; and/or
mass percentages of components in the second negative electrode active material layer are: 95 wt % to 99 wt % second negative electrode active material, 0.4 wt % to 2 wt % second conductive agent, 0.5 wt % to 2.5 wt % second binder, and 0.3 wt % to 1.3 wt % second thickener; and/or
mass percentages of components in the third negative electrode active material layer are: 93 wt % to 98 wt % third negative electrode active material, 0.4 wt % to 2 wt % third conductive agent, 0.5 wt % to 3.5 wt % third binder, and 0.3 wt % to 1.7 wt % third thickener.

12. The negative electrode plate according to claim 1, wherein a mass ratio of the first graphite material to the first amorphous carbon material is (60 wt % to 94 wt %):(40 wt % to 6 wt %).

13. The negative electrode plate according to claim 1, wherein a mass ratio of the third graphite material to the second amorphous carbon material is (60 wt % to 94 wt %):(40 wt % to 6 wt %).

14. The negative electrode plate according to claim 1, wherein stripe coating is applied to a surface of the negative electrode current collector.

15. The negative electrode plate according to claim 1, wherein the negative electrode plate further comprises tabs, and there are at least three tabs.

16. The negative electrode plate according to claim 15, wherein the tabs are disposed in a foil uncoating region disposed along the width direction of the negative electrode current collector and close to the first coating region.

17. The negative electrode plate according to claim 15, wherein the tabs are disposed close to the first coating region, and the tabs are formed by extension of the negative electrode current collector.

18. A battery, wherein the battery comprises the negative electrode plate according to claim 1.
